(19) United States
(12) Patent Application Publication
(10) Pub. No.: US 2022/0025581 A1
(43) Pub. Date: Jan. 27, 2022

(54) THERMAL INSULATING PAPER AND METHOD FOR PRODUCING A THERMAL INSULATING PAPER

(71) Applicant: Schaeffler Technologies AG & Co. KG, Herzogenaurach (DE)

(72) Inventors: Stefan Steinmetz, Grünstadt (DE); Gregor Mattern, Schöneberg (DE); Lothar Hofmann, Neumarkt (DE)

(73) Assignee: Schaeffler Technologies AG & Co. KG, Herzogenaurach (DE)

(21) Appl. No.: 17/296,267

(22) PCT Filed: Nov. 20, 2019
(86) PCT No.: PCT/DE2019/100992

§ 371 Date: May 24, 2021

(30) Foreign Application Priority Data
Dec. 11, 2018 (DE) 10 2018 131 706.9

(51) Int. Cl. D21H 17/00; H01B 3/52; D21H 27/02; D21H 13/26; D21H 13/42; D21H 17/68; D21H 17/37; D21H 17/48; C09J 7/21; C09J 11/04; C09J 11/08

(52) U.S. Cl. CPC D21H 17/74; H01B 3/52; D21H 27/02; D21H 13/26; D21H 13/42; D21H 17/68; C09J 2400/283; D21H 17/48; C09J 7/21; C09J 11/04; C09J 11/08; C09J 2203/326; C09J 2301/41; D21H 17/37

(57) ABSTRACT

A method for producing a thermal insulating paper includes producing the thermal insulating paper in a classic paper production process from a raw material having materials with good thermal properties and materials with electrically insulating properties in a paper matrix. A thermal insulating paper produced using the above method may include inorganic fibers, electrical insulators, aramid fibers, or binders.

### CROSS-REFERENCE TO RELATED APPLICATIONS

This application is the United States National Phase of PCT Appln. No. PCT/DE2019/100992 filed Nov. 20, 2019, which claims priority to German Application No. DE102018131706.9 filed Dec. 11, 2018, the entire disclosures of which are incorporated by reference herein.

### TECHNICAL FIELD

The present disclosure relates to a thermal insulating paper and a method for producing a thermal insulating paper.

### BACKGROUND

From the European patent EP 2 831 324 B1 an electrical paper is known which includes the following: a fibrous substrate having a first side and a second side opposite to the first side, and a solidified product of a fiber composition including: thirty-five to seventy percent by weight of polyimide fibers, at least five percent by weight of fibers including aromatic polyamide fibers, liquid crystal polymer fibers or a combination at least one of the foregoing fibers, and including at least ten percent by weight of polycarbonate fibers, each based on the total weight of the fibers in the fiber composition; a first layer of polyimide film arranged on the first side of the fibrous substrate; and a second layer of polyimide film arranged on the second side of the fibrous substrate, wherein the electrical paper has a thickness of greater than zero to less than seventy-five millimeters and is non-porous.

A transformer paper is known from the European patent EP 2 831 325 B1, including a consolidated product of a fiber composition, the fiber composition including, based on the total weight of the fibers in the fiber composition, thirty-five to seventy percent by weight of polyetherimide homopolymer fibers, polyetherimide copolymer fibers or a combination of the above; at least five percent by weight of binder fibers and five to thirty percent by weight of liquid crystal polymer fibers.

### SUMMARY

The present disclosure provides a method for producing a thermal insulating paper. The thermal insulating paper is produced in a classic paper production process from a raw material that contains both materials with good thermal properties and materials with electrically insulating properties in a paper matrix. A raw material in classic paper production basically consists of fibers, auxiliary materials, and water. In addition to vegetable fibers, animal, mineral, or synthetic fibers are used less often in classic paper production. In the method according to the present disclosure, inorganic fibers and electrical insulators are added to the raw material to improve the mechanical and thermal properties of the thermal insulating paper.

In an exemplary embodiment of the thermal insulating paper, the thermal insulating paper is thermally fixed. For example, the raw material is pre-dried in a drying section. The pre-dried thermal insulating paper can then be thermally fixed by the action of heat during further processing, for example in an oven or in a press.

In another exemplary embodiment of the thermal insulating paper, the thermal insulating paper is provided with at least one coating, e.g., with an adhesive layer. Conventional coating methods can be used for coating. According to a further aspect, constituents such as rubber are added to the raw material for producing the thermal insulating paper to provide an adhesive function of the thermal insulating paper.

In another exemplary embodiment of the thermal insulating paper, the thermal insulating paper is folded, pressed, punched and/or deformed. The individual method steps of folding, pressing, punching, and deforming can be used both individually and in any combination. The individual method steps can also be combined with further method steps, e.g., thermal method steps.

In the case of a thermal insulating paper produced in a method described above, for example, the thermal insulating paper contains inorganic fibers, such as basalt fibers. As a result, the mechanical and thermal properties of the thermal insulating paper can be effectively improved.

In an exemplary embodiment of the thermal insulating paper, the thermal insulating paper contains electrical insulators such as boron nitride, aluminum nitride and/or mullite. Mullite is a rather seldom occurring mineral from the mineral class of silicates. Boron nitride is a boron-nitrogen compound that occurs in various modifications. Aluminum nitride is a chemical compound of aluminum and nitrogen. With the claimed insulators, the electrically insulating properties of the thermal insulating paper could be effectively improved.

In another exemplary embodiment of the thermal insulating paper, the thermal insulating paper contains aramid fibers. This can effectively improve the mechanical properties of the thermal insulating paper.

In another exemplary embodiment of the thermal insulating paper, the thermal insulating paper contains binders such as phenolic resin and/or acrylate. This enables the thermal insulating paper to have an additional adhesive function. This simplifies the processing of the thermal insulating paper.

In another exemplary embodiment of the thermal insulating paper, the thermal insulating paper has a thickness of one hundred to three hundred micrometers. The thickness of the thermal insulating paper can be positively influenced by pressing under the action of heat.

In another exemplary embodiment of the thermal insulating paper, the thermal insulating paper is self-adhesive. This simplifies the use of the thermal insulating paper, e.g., in connection with electrical machines. The thermal insulating paper can, however, also be used for other purposes, for example in combination with rolling bearings, e.g., on the outer rings of rolling bearings.

The present disclosure further relates to an electrical machine, e.g., a stator of an electrical machine with stator recesses or stator slots, with pieces of the thermal insulating paper described above. The electrical machine is designed, for example, like the electric machine described in the German patent application DE 10 2013 201 758 A1.

The present disclosure also relates to a rolling bearing ring, as disclosed in the German patent application DE 10 2013 223 677 A1, having an outer ring which has an outer part and an inner part having a roll body raceway, both parts being replaced by a previously described thermal insulating paper or a piece of such a thermal insulating paper are electrically insulated from one another and, moreover, hold the outer part and the inner part together in a composite.

The thermal insulating paper is permanently temperature-resistant at a temperature of one hundred and eighty degrees Celsius. The thermal insulating paper also has a thermal conductivity that is greater than 2.5 watts per meter-Kelvin. In addition, with a thickness of two hundred micrometers, the thermal insulating paper has a dielectric strength that is greater than four kilovolts.

### DETAILED DESCRIPTION

Further advantages, features and details of the present disclosure emerge from the following description, in which various exemplary embodiments are described in detail.

The disclosed thermal insulating paper is manufactured in a classic paper manufacturing process. The method permits a wide variation in terms of the materials used to optimize the electrical and thermal properties. In addition, the production of the thermal insulating paper in the classic paper manufacturing process is inexpensive. In addition, the claimed thermal insulating paper offers advantages in terms of the workability and modifiability thereof with regard to an assembly concept in the manufacture of electric motors.

By using electrically insulating but thermally conductive material, the properties can be changed in such a way that they meet the increased requirements. In terms of implementation, this means that the recipe and the manufacturing process are adapted to the changed requirements.

Here, inorganic fibers, such as basalt, are used to improve the mechanical and thermal properties, and these are processed with materials that have a high thermal conductivity but are electrical insulators, such as boron nitride, aluminum nitride, or mullite. To ensure good strength and fixation of these substances in the paper matrix, aramid fibers and binders, such as phenolic resin and/or acrylates, are used.

Due to the fixation of the insulation via a thermal work step, additional substances are added to the recipe for this purpose.

The paper production can also be combined with various coating methods, if necessary, to adjust the mechanical, electrical or processing behavior or the properties of the thermal insulating paper.

1. A method for producing a thermal insulating paper, wherein the thermal insulating paper is produced in a classic paper production process from a raw material comprising materials with good thermal properties and materials with electrically insulating properties in a paper matrix.

2. The method of claim 1, wherein the thermal insulating paper is thermally fixed.

3. The method of claim 1, wherein the thermal insulating paper is provided with a coating.

4. The method of claim 1, wherein the thermal insulating paper is folded, pressed, punched, or deformed.

5. A thermal insulating paper produced using the method of claim 1, comprising inorganic fibers.

6. The thermal insulating paper of claim 5, further comprising electrical insulators.

7. The thermal insulating paper of claim 5, wherein the thermal insulating paper comprises aramid fibers.

8. The thermal insulating paper of claim 5, wherein the thermal insulating paper comprises binders.

9. The thermal insulating paper of claim 5, wherein the thermal insulating paper comprises a thickness of one hundred to three hundred micrometers.

10. The thermal insulating paper of claim 5, wherein the thermal insulating paper is self-adhesive.

11. The thermal insulating paper of claim 3 wherein the coating is an adhesive layer.

12. The thermal insulating paper of claim 5 wherein the inorganic fibers are basalt fibers.

13. The thermal insulating paper of claim 6 wherein the electrical insulators are selected from the group consisting of boron nitride, aluminum nitride, mullite and combinations thereof.

14. The thermal insulating paper of claim 8 wherein the binders are selected from the group consisting of phenolic resin, acrylate and combinations thereof.
